(19) United States
(12) Patent Application Publication
(10) Pub. No.: US 2017/0259211 A1
(43) Pub. Date: Sep. 14, 2017

(54) REVERSE OSMOSIS FILTRATION SYSTEM WITHOUT PRESSURE TANKS

(71) Applicants: Ching Hsiung LIN, Pingtung (TW); Kemflo (Nanjing) Environmental Technology Co., Ltd, Nanjing (CN); Kemflo International Co., Ltd., Pingtung (TW)

(72) Inventor: Jack LIN, Nanjing (CN)

(21) Appl. No.: 15/068,204

(22) Filed: Mar. 11, 2016

(51) Int. Cl. B01D 61/02; C02F 1/28; C02F 1/44; B01D 39/20; B01D 61/08

(52) U.S. Cl. CPC B01D 61/022; B01D 61/025; B01D 39/2055; B01D 61/08; C02F 1/441; C02F 1/283; B01D 2311/06; B01D 2317/02

(57) ABSTRACT

The present invention provides a reverse osmosis filtration system without pressure tanks consisting of a filter element connecting member and external filter elements and having a raw water inlet, a pure water outlet and a wastewater outlet. In the reverse osmosis filtration system of the present invention, filter elements can be quickly and easily installed for avoiding leakage occurs during the installation or replacement of the filter elements, so that users can conveniently install or replace the filter elements by themselves and purposes of convenient operation and leakage prevention can be achieved. Meanwhile, water storage pressure tanks and pumps are omitted in the reverse osmosis filtration system of the present invention for reducing manufacturing costs and effectively avoiding secondary pollution.

### FIELD OF THE INVENTION

The present invention relates to a water filtration system, and more particularly to a reverse osmosis filtration system without pressure tanks.

### BACKGROUND OF THE INVENTION

With the improvement of the quality of life and increased water pollution, people are paying more attention to drinking water safety, so that various types of water filters/purifiers are put in the market to meet consumers' needs, among which reverse osmosis filters are getting more and more popular in consumers.

Some problems occur during the usage of conventional reverse osmosis filters by now, such as: 1. a large amount of concentration water, which usually has a good water quality, is produced by filtering raw water through reverse osmosis membrane, and it is unfortunate that the concentration water is directly discharged as wastewater, which will lead to serious waste of water resources; 2. the reverse osmosis filter is unable to satisfy daily water consumption due to its slower rate of filtration, so that a conventional reverse osmosis filter must be provided with a water storage pressure tank. However, disposition of the water storage pressure tank may easily lead to secondary pollution and then impact drinking water safety; and 3. filter elements in a conventional reverse osmosis filter are usually connected to each other through external pipeline and need special tools to assist with replacement, which will cause leakage risks, inconvenient installations or replacements and complex operation during uses.

As a result, it is necessary to provide a new reverse osmosis filtration system, which may increase water outlets and omit water storage pressure tanks for avoiding secondary pollution, while assure the quality of pure water and reduce wastewater outlets for purpose of saving water.

### SUMMARY OF THE INVENTION

An objective of the present invention is to provide a novel reverse osmosis filtration system in which the filter elements can be quickly and easily installed for avoiding leakage occurs during the installation or replacement of the filter elements, so that users can conveniently install or replace the filter elements by themselves and purposes of convenient operation and leakage prevention can be achieved. Meanwhile, water storage pressure tanks are omitted in the reverse osmosis filtration system of the present invention for avoiding secondary pollution. In addition, two reverse osmosis membranes are contained in the reverse osmosis filtration system of the present invention to assure the quality of pure water and reduce wastewater outlets for purpose of saving water.

For accomplishing the above-mentioned objective, the present invention provides reverse osmosis filtration system without pressure tanks, consisting of a filter element connecting member and external filter elements and having a raw water inlet, a pure water outlet and a wastewater outlet, wherein

the external filter elements are three-grade-filter elements including a primary filter element, a secondary filter element, a tertiary filter element;

the filter element connecting member contains a connecting body having an internal water path side and a filter element installing side;

an internal water path is formed on the internal water path side;

a primary filter element coupling base, a secondary filter element coupling base and a tertiary filter element coupling base are provided on the filter element installing side, to which the corresponding primary filter element, the secondary filter element or the tertiary filter element is fluidly connected respectively;

the raw water inlet, the pure water outlet and the wastewater outlet are fluidly connected to the external filter elements through the internal water path; and, the filter elements are fluidly connected to each other through the internal water path.

In one embodiment of the present invention, the secondary filter element and the tertiary filter element are both reverse osmosis filter elements.

In one embodiment of the present invention, the pure water obtained by filtering the wastewater effluent of the secondary filter element through the tertiary filter element, together with the pure water of the secondary filter element, is discharged from the pure water outlet of the reverse osmosis filtration system without pressure tanks.

In one embodiment of the present invention, a post carbon filter is connected to the connecting body of the filter element connecting member for a sealed fluidic connection with the internal water path; and, the pure water obtained by filtering the wastewater effluent of the secondary filter element through the tertiary filter element and the pure water of the secondary filter element are filtered through the post carbon filter followed by being discharged from the pure water outlet of the reverse osmosis filtration system without pressure tanks.

In one preferred embodiment of the present invention, in the filter element connecting member,

on the filter element installing side,

the primary filter element coupling base is provided with a primary filter inlet and a primary filter pure water outlet, the secondary filter element coupling base is provided with a secondary filter inlet, a secondary filter pure water outlet and a secondary filter wastewater outlet, and the tertiary filter element coupling base is provided with a tertiary filter inlet, a tertiary filter pure water outlet and a tertiary filter wastewater outlet;

on the internal water path side,

the internal water path is divided into a primary filter inlet zone, a primary filter pure water outlet zone, a secondary filter pure water outlet zone, a secondary filter wastewater outlet zone, a tertiary filter wastewater outlet zone, a post carbon filter inlet zone and a post carbon filter pure water outlet zone; wherein

the raw water inlet of the reverse osmosis filtration system without pressure tanks has a fluidic connection with the primary filter inlet through the primary filter inlet zone, the primary filter pure water outlet has a fluidic connection with the secondary filter inlet through the primary filter pure water outlet zone;

the secondary filter pure water outlet has a fluidic connection with the tertiary filter pure water outlet through the secondary filter pure water outlet zone; the secondary filter pure water outlet zone has a fluidic connection with the post carbon filter inlet zone through a first external pipeline; the post carbon filter inlet zone has a sealed fluidic connection with the post carbon filter through a second external pipeline so as to fluidly connect to the post carbon filter pure water outlet zone through a third external pipeline; the post carbon filter pure water outlet zone has a fluidic connection with the pure water outlet of the reverse osmosis filtration system without pressure tanks; and

the secondary filter wastewater outlet has a fluidic connection with the tertiary filter inlet through the secondary filter wastewater outlet zone; the tertiary filter wastewater outlet has a fluidic connection with the wastewater outlet of the reverse osmosis filtration system without pressure tanks through the tertiary filter wastewater outlet zone.

In one preferred embodiment of the present invention, the internal water path is formed on the internal water path side by hot-plate welding.

In one preferred embodiment of the present invention, a flowmeter is positioned on the first external pipeline.

In one preferred embodiment of the present invention, a primary filter element coupling block, a secondary filter element coupling block and a tertiary filter element coupling block are separately disposed on the primary filter element coupling base, the secondary filter element coupling base and the tertiary filter element coupling base to fluidly connect the primary filter element, the secondary filter element, the tertiary filter element with the corresponding grade of the filter element coupling bases respectively; wherein

the primary filter element coupling block contains a first mid-block and a first cap;

the first mid-block is provided with a primary filter element inlet end matching the primary filter inlet of the primary filter element coupling base, and a primary filter element outlet end matching the primary filter pure water outlet of the primary filter element coupling base;

a first arc groove and a first circular groove corresponding to the primary filter element outlet end are formed on the first cap, through which the primary filter element inlet end and the primary filter element outlet end pass, so that the first mid-block slides along the first arc groove;

the secondary filter element coupling block contains a second mid-block and a second cap;

the second mid-block is provided with a secondary filter element inlet end matching the secondary filter inlet of the secondary filter element coupling base, a secondary filter element outlet end matching the secondary filter pure water outlet of the secondary filter element coupling base, and a secondary filter element wastewater outlet end matching the secondary filter wastewater outlet of the secondary filter element coupling base;

a second arc groove and a second circular groove corresponding to the secondary filter element outlet end and the secondary filter element wastewater outlet end are formed on the second cap, through which the secondary filter element inlet end, the secondary filter element outlet end and the secondary filter element wastewater outlet end pass, so that the second mid-block slides along the second arc groove;

the tertiary filter element coupling block contains a third mid-block and a third cap;

the third mid-block is provided with a tertiary filter element inlet end matching the tertiary filter inlet of the tertiary filter element coupling base, a tertiary filter element outlet end matching the tertiary filter pure water outlet of the tertiary filter element coupling base, and a tertiary filter element wastewater outlet end matching the tertiary filter wastewater outlet of the tertiary filter element coupling base;

a third arc groove and a third circular groove corresponding to the tertiary filter element outlet end and the tertiary filter element wastewater outlet end are formed on the third cap, through which the tertiary filter element inlet end, the tertiary filter element outlet end and the tertiary filter element wastewater outlet end pass, so that the third mid-block slides along the third arc groove.

In one embodiment of the present invention, the filter element connecting member further contains a housing for receiving the connecting body, and a base to which the housing is connected and mounted.

In one embodiment of the present invention, the pure water outlet of the reverse osmosis filtration system without pressure tanks is connected to a dual switch non-pressure tap.

In one embodiment of the present invention, screw threads are formed on the first cap, the second cap and the third cap, so that the primary filter element coupling block the secondary filter element coupling block and the tertiary filter element coupling block can be stability mounted on the corresponding grade of the coupling base by engaging the screw threads with the matching bolts.

In the reverse osmosis filtration system of the present invention, conventional external connecting pipelines are replaced with the internal water path for avoiding leakage occurs during use, and two reverse osmosis membranes are disposed to assure the quality of pure water and reduce wastewater outlets for purpose of saving water.

In the reverse osmosis filtration system of the present invention, filter elements can be quickly and easily installed for avoiding leakage occurs during the installation or replacement of the filter elements, so that users can conveniently install or replace the filter elements by themselves and purposes of convenient operation and leakage prevention can be achieved. Meanwhile, water storage pressure tanks and pumps are omitted in the reverse osmosis filtration system of the present invention for reducing manufacturing costs and effectively avoiding secondary pollution.

### BRIEF DESCRIPTION OF THE DRAWINGS

FIG. 1 is a perspective view illustrating a reverse osmosis filtration system without pressure tanks in one embodiment of the present invention;

FIG. 2 is an exploded perspective view illustrating the reverse osmosis filtration system without pressure tanks of FIG. 1;

FIG. 3 is an exploded perspective view illustrating the filter element connecting member in the reverse osmosis filtration system without pressure tanks of FIG. 1;

FIG. 4 is a perspective view illustrating the connecting body of the filter element connecting member of FIG. 3;

FIG. 5 is an exploded perspective view illustrating the filter element installing side of the connecting body of FIG. 3;

FIG. 6A is a front view illustrating the internal water path side of the connecting body of FIG. 3;

FIG. 6B is a structural schematic view of the lower layer 211 of the internal water path on the internal water path side of FIG. 3; wherein

10—filter element connecting member;
101—housing, 102—base;
11—external filter elements;
111—primary filter element, 112—secondary filter element, 113—tertiary filter element, 114—post carbon filter;
1141—post carbon filter inlet end, 1142—post carbon filter pure water outlet end;
12—raw water inlet, 13—pure water outlet, 14—waste water outlet;
20—connecting body;
21—internal water path side, 22—filter element installing side;
211—lower layer of internal water path, 212—upper layer of internal water path;
221—primary filter element coupling base, 222—secondary filter element coupling base, 223—tertiary filter element coupling base;
2211—primary filter inlet, 2212—primary filter pure water outlet;
2221—secondary filter inlet, 2222—secondary filter pure water outlet), 2223—secondary filter wastewater outlet;
2231—tertiary filter inlet, 2232—tertiary filter pure water outlet, 2233—tertiary filter wastewater outlet;
231—primary filter inlet zone, 232—primary filter pure water outlet zone, 233—secondary filter pure water outlet zone, 234—secondary filter wastewater outlet zone, 235—tertiary filter wastewater outlet zone, 236—post carbon filter inlet zone, 237—post carbon filter pure water outlet zone;
241—first external pipeline, 242—second external pipeline, 243—third external pipeline, 244—flowmeter;
30—primary filter element coupling block;
31—first mid-block, 32—first cap;
311—primary filter element inlet end, 312—primary filter element outlet end;
321—first arc groove, 322—first circular groove;
40—secondary filter element coupling block;
41—second mid-block, 42—second cap;
411—secondary filter element inlet end, 412—secondary filter element outlet end, 413—secondary filter element wastewater outlet end;
421—second arc groove, 422—second circular groove;
50—tertiary filter element coupling block;
51—third mid-block, 52—third cap;
511—tertiary filter element inlet end, 512—tertiary filter element outlet end, 513—tertiary filter element wastewater outlet end.

### DESCRIPTION OF THE INVENTION

Embodiments, for purposes of explanation, are set forth in order to provide a thorough understanding of the present invention and not to limit the technical solution of the present invention.

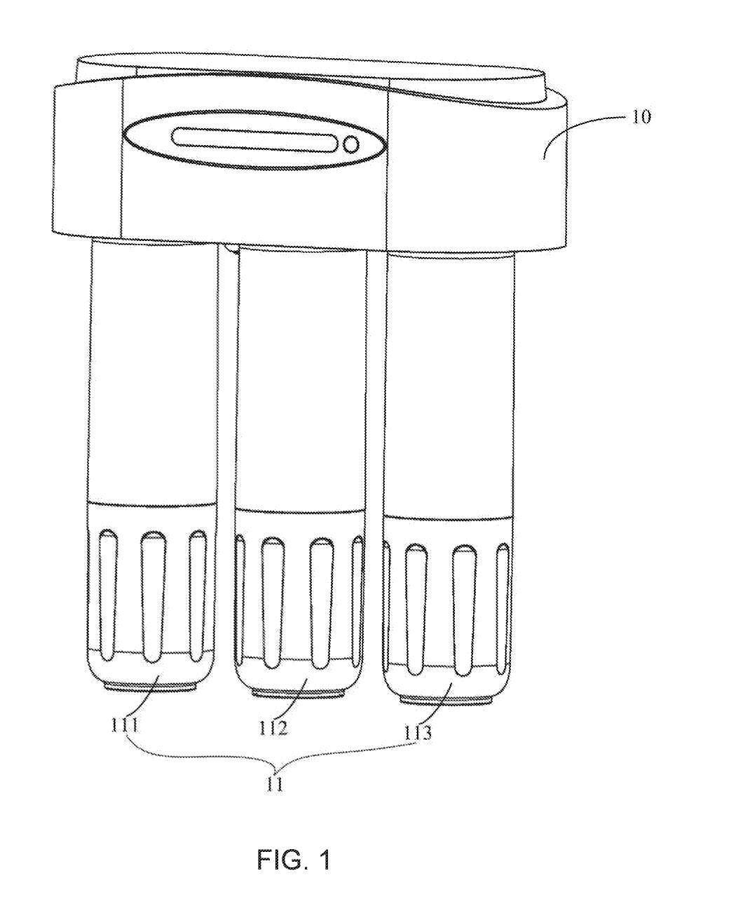

Referring now to FIG. 1, FIG. 1 is a perspective view illustrating a reverse osmosis filtration system without pressure tanks in one embodiment of the present invention. In the present embodiment, a reverse osmosis filtration system without pressure tanks consists of a filter element connecting member 10 and external filter elements 11. The external filter elements 11 are three-grade-filter elements including a primary filter element 111, a secondary filter element 112 and a tertiary filter element 113, wherein the both reverse osmosis filter elements. As illustrated in FIG. 5, the reverse osmosis filtration system without pressure tanks has a raw water inlet 12, a pure water outlet 13 and a wastewater outlet 14.

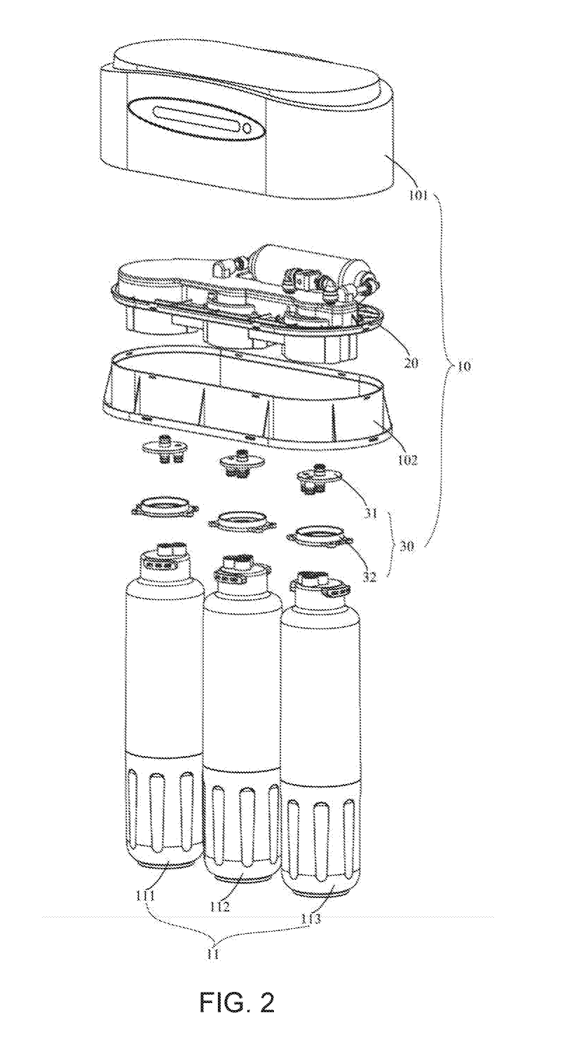

Referring now to FIG. 2, FIG. 2 is an exploded perspective view illustrating the reverse osmosis filtration system without pressure tanks of the present embodiment. As illustrated in FIG. 2, in the present embodiment, the filter element connecting member 10 contains a housing 101, a base 102, a connecting body 20 and three filter element coupling block. Only the tertiary filter element coupling block 50 is shown in FIG. 2. As illustrated in FIG. 2, the tertiary filter element coupling block 50 contains a third mid-block 51 and a third cap 52.

The detail structure of the filter element connecting member 10 is described in detail hereinafter.

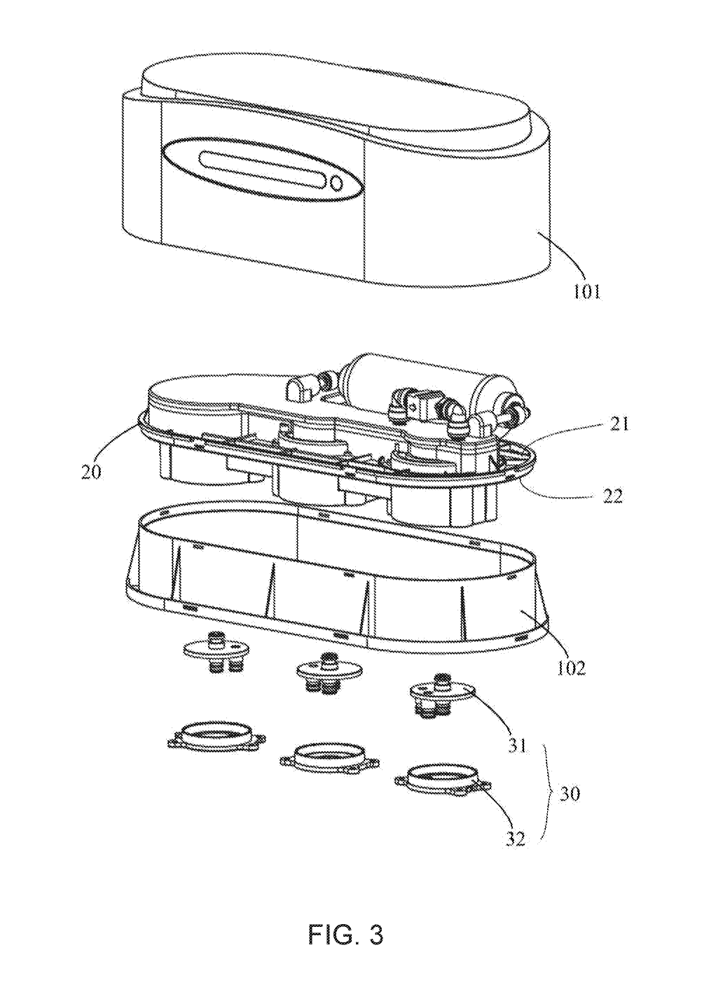

Referring now to FIG. 3, FIG. 3 is an exploded perspective view illustrating the filter element connecting member 10 in the reverse osmosis filtration system without pressure tanks of the present embodiment. As illustrated in FIG. 3, the connecting body 20 has an internal water path side 21 and a filter element installing side 22, wherein the internal water path side 21 and the filter element installing side 22 share one baseplate and has a fluid connection with each other via holes formed on the baseplate. In the present embodiment, the connecting body 20 is mounted on the base 102 followed by engaging the housing to the base 102, so that the assembly of the filter element connecting member 10 is finished.

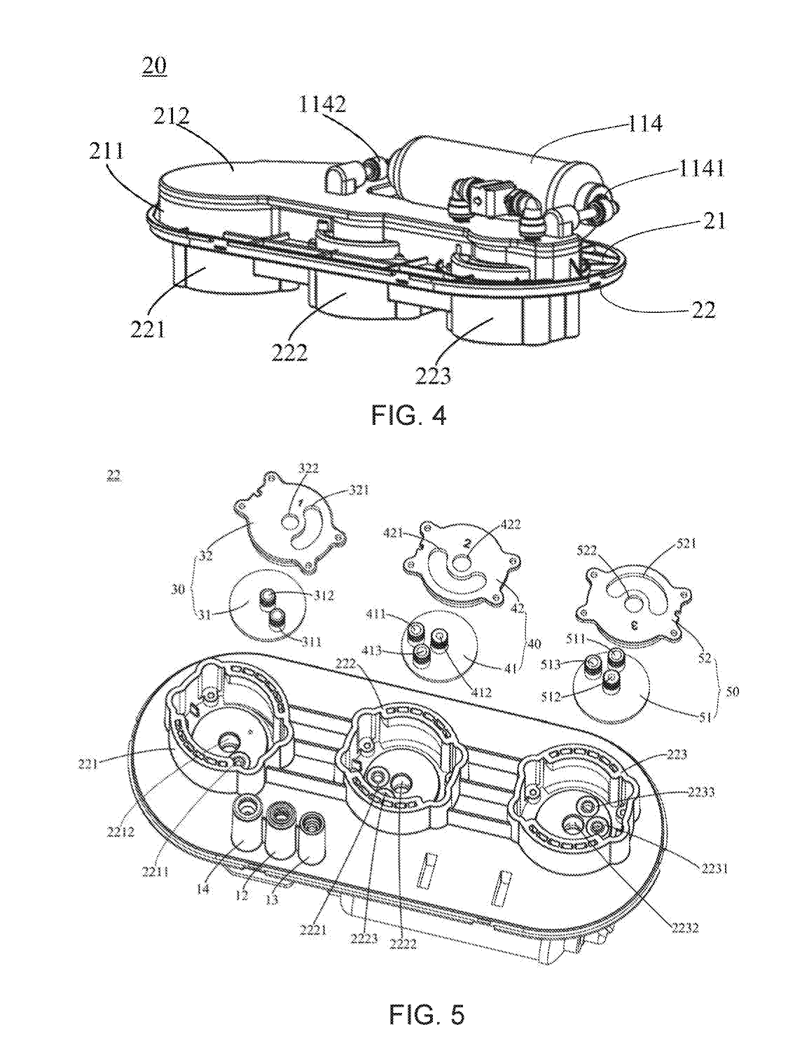

The detail structures of the connecting body 20, the internal water path side 21 and filter element installing side 22 are described in detail hereinafter by referring to FIGS. 4 to 6. For illustration purposes, the holes for fluid connection between the internal water path side 21 and the filter element installing side 22 are named different names.

Referring now to FIG. 4, FIG. 4 is a perspective view illustrating the connecting body 20. As illustrated in FIG. 4, the internal water path consisting of the lower layer 211 and the upper layer 212 is formed on the internal water path side 21, and a primary filter element coupling base 221, a secondary filter element coupling base 222 and a tertiary filter element coupling base 223 are provided on the filter element installing side 22. A post carbon filter 114 has a sealed fluidic connection with the internal water path. The post carbon filter 114 is provided with a post carbon filter inlet end 1141 and a post carbon filter pure water outlet end 1142.

The detail structure of the filter element installing side 22 is described in detail hereinafter by referring to FIG. 5.

Referring now to FIG. 5, FIG. 5 is an exploded perspective view illustrating the filter element installing side 22. As illustrated in FIG. 5, a primary filter element coupling base 221, a secondary filter element coupling base 222 and a tertiary filter element coupling base 223 are provided on the filter element installing side 22. The primary filter element coupling base 221 is provided with a primary filter inlet 2211 and a primary filter pure water outlet 2212, the secondary filter element coupling base 222 is provided with a secondary filter inlet 2221, a secondary filter pure water outlet 2222 and a secondary filter wastewater outlet 2223, and the tertiary filter element coupling base 223 is provided with a tertiary filter inlet 2231, a tertiary filter pure water outlet 2232 and a tertiary filter wastewater outlet 2233.

Referring to FIG. 5, a primary filter element coupling block 30, a secondary filter element coupling block 40 and a tertiary filter element coupling block 50 are separately disposed on the primary filter element coupling base 221, the secondary filter element coupling base 222 and the tertiary filter element coupling base 223. The primary filter element coupling block 30, the secondary filter element coupling block 40 and the tertiary filter element coupling block 50 are used to fluidly connect the primary filter element 111, the secondary filter element 112, the tertiary filter element 113 with the corresponding grade of the filter element coupling bases respectively.

As illustrated in FIG. 5, the primary filter element coupling block 30 contains a first mid-block 31 and a first cap 32. The first mid-block 31 is provided with a primary filter element inlet end 311 and a primary filter element outlet end 312. The primary filter element inlet end 311 matches the primary filter inlet 2211 of the primary filter element coupling base 221, and a primary filter element outlet end 312 matches the primary filter pure water outlet 2212 of the primary filter element coupling base 221. A first arc groove 321 and a first circular groove 322 corresponding to the primary filter element outlet end 312 are formed on the first cap 32, through which the primary filter element inlet end 311 and the primary filter element outlet end 312 pass, so that the first mid-block 31 can slide along the first arc groove 321.

Referring to FIG. 5, similar to the primary filter element coupling block 30, the secondary filter element coupling block 40 contains a second mid-block 41 and a second cap 42. The second mid-block 41 is provided with a secondary filter element inlet end 411, a secondary filter element outlet end 412 and a secondary filter element wastewater outlet end 413. The secondary filter element inlet end 411 matches the secondary filter inlet 2211 of the secondary filter element coupling base 222, the secondary filter element outlet end 412 matches the secondary filter pure water outlet 2222 of the secondary filter element coupling base 222, and the secondary filter element wastewater outlet end 412 matches the secondary filter wastewater outlet 2223 of the secondary filter element coupling base 222. A second arc groove 421 and a second circular groove 422 corresponding to the secondary filter element outlet end 412 are formed on the second cap 42, through which the secondary filter element inlet end 411, the secondary filter element outlet end 412 and the secondary filter element wastewater outlet end 413 pass, so that the second mid-block 41 can slide along the second arc groove 421.

Referring to FIG. 5, similar to the primary filter element coupling block 30, the tertiary filter element coupling block 50 contains a third mid-block 51 and a third cap 52. The third mid-block is provided with a tertiary filter element inlet end 511, a tertiary filter element outlet end 512 and a tertiary filter element wastewater outlet end 513. The tertiary filter element inlet end 511 matches the tertiary filter inlet 2231 of the tertiary filter element coupling base 223, the tertiary filter element outlet end 512 matches the tertiary filter pure water outlet 2232 of the tertiary filter element coupling base 223, and a tertiary filter element wastewater outlet end 513 matches the tertiary filter wastewater outlet 2233 of the tertiary filter element coupling base 223. A third arc groove 521 and a third circular groove 522 corresponding to the tertiary filter element outlet end 512 are formed on the third cap 52, through which the tertiary filter element inlet end 511, the tertiary filter element outlet end 512 and the tertiary filter element wastewater outlet end 513 pass, so that the third mid-block 51 can slide along the third arc groove 521.

It can be understood that, for stability of the installation, screw threads (not shown in FIG.s) are formed on the first cap 32, the second cap 42 and the third cap 52, so that the primary filter element coupling block 30, the secondary filter element coupling block 40 and the tertiary filter element coupling block 50 can be stability mounted on the corresponding grade of the coupling base by engaging the screw threads with the matching bolts. It is certain that, the person skilled in the art can replace the screw threads and bolts with other well-known fix install methods.

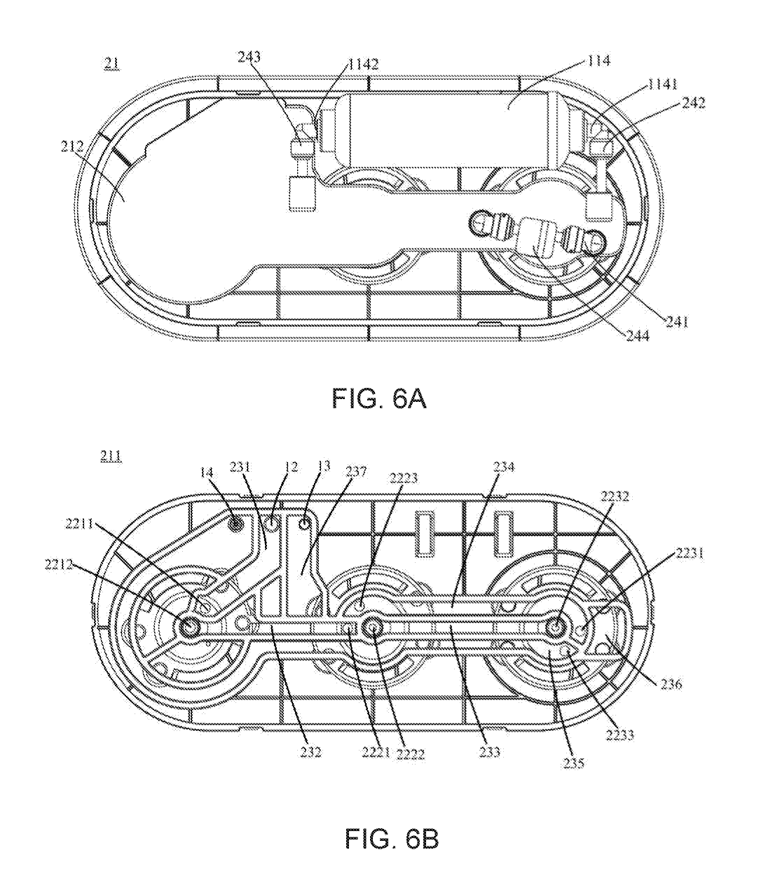

The detail structure of the internal water path side 21 is described in detail hereinafter by referring to FIGS. 6A and 6B.

Referring to FIGS. 6A and 6B, wherein FIG. 6A is a front view illustrating the internal water path side 21 and FIG. 6B is a structural schematic view of the lower layer 211 of the internal water path on the internal water path side.

As illustrated in FIG. 6B, the internal water path is divided into a primary filter inlet zone 231, a primary filter pure water outlet zone 232, a secondary filter pure water outlet zone 233, a secondary filter wastewater outlet zone 234, a tertiary filter wastewater outlet zone 235, a post carbon filter inlet zone 236 and a post carbon filter pure water outlet zone 237.

As illustrated in FIG. 6B, the raw water inlet 12 of the reverse osmosis filtration system without pressure tanks has a fluidic connection with the primary filter inlet 2211 through the primary filter inlet zone 231, so that raw water can be filtered through the primary filter element 111. The primary filter pure water outlet 2212 has a fluidic connection with the secondary filter inlet 2221 through the primary filter pure water outlet zone 232, so that pure water of the primary filter element 111 can be filtered through the secondary filter element 112. The secondary filter wastewater outlet 2223 has a fluidic connection with the tertiary filter inlet 2231 through the secondary filter wastewater outlet zone 234, so that wastewater of the secondary filter element 112 is filtered through the tertiary filter element to assure the quality of pure water and reduce wastewater outlets. The tertiary filter waste water outlet 2233 has a fluidic connection with the waste water outlet 14 of the reverse osmosis filtration system without pressure tanks through the tertiary filter wastewater outlet zone 235, so that wastewater of the tertiary filter element can be discharged from the reverse osmosis filtration system through the wastewater outlet 14.

Referring to FIGS. 6A and 6B, the secondary filter pure water outlet 2222 has a fluidic connection with the tertiary filter pure water outlet 2232 through the secondary filter pure water outlet zone 233, so that the pure water of the secondary filter element 112 and pure water of the tertiary filter element 113 is combined in the secondary filter pure water outlet zone 233 and flows into the post carbon filter inlet zone 236 through the first external pipeline 241 positioned on upper layer 212 of the internal water path. The post carbon filter inlet zone 236 has a sealed fluidic connection with the post carbon filter inlet 1141 through a second external pipeline 242, so that the pure water of the secondary filter element 112 and pure water of the tertiary filter element 113 is filtered through the post carbon filter 114. The post carbon filter pure water outlet end 1142 has a sealed fluidic connection with the post carbon filter pure water outlet zone 237 through a third external pipeline 243, so that the pure water obtained by being filtered through the post carbon filter 114 flows into the post carbon filter pure water outlet zone 237 and finally flows out of the reverse osmosis filtration system through the pure water outlet 13 having a fluidic connection with the post carbon filter pure water outlet zone 237.

In a better design, a flowmeter 244 is positioned on the first external pipeline 241.

It is certain that the pure water outlet 13 of the reverse osmosis filtration system without pressure tanks can be connected to a dual switch non-pressure tap in practical uses.

In the reverse osmosis filtration system of the present invention, conventional external connecting pipelines are replaced with the internal water path for avoiding leakage occurs during use, and two reverse osmosis membranes are disposed to assure the quality of pure water and reduce wastewater outlets for purpose of saving water.

In the reverse osmosis filtration system of the present invention, filter elements can be quickly and easily installed for avoiding leakage occurs during the installation or replacement of the filter elements, so that users can conveniently install or replace the filter elements by themselves and purposes of convenient operation and leakage prevention can be achieved. Meanwhile, water storage pressure tanks and pumps are omitted in the reverse osmosis filtration system of the present invention for reducing manufacturing costs and effectively avoiding secondary pollution.

The present invention has been described with relative embodiments which are examples of the present invention only. It should be noted that the embodiments disclosed are not the limit of the scope of the present invention. Conversely, modifications to the scope and the spirit of the claims, as well as the equal of the claims, are within the scope of the present invention.

1. A reverse osmosis filtration system without pressure tanks, consisting of a filter element connecting member and external filter elements and having a raw water inlet, a pure water outlet and a wastewater outlet, characterized in that:
the external filter elements are three-grade-filter elements including a primary filter element, a secondary filter element, a tertiary filter element;
the filter element connecting member contains a connecting body having an internal water path side and a filter element installing side;
an internal water path is formed on the internal water path side;
a primary filter element coupling base, a secondary filter element coupling base and a tertiary filter element coupling base are provided on the filter element installing side, to which the corresponding primary filter element, the secondary filter element or the tertiary filter element is fluidly connected respectively;
the raw water inlet, the pure water outlet and the wastewater outlet are fluidly connected to the external filter elements through the internal water path; and,
the filter elements are fluidly connected to each other through the internal water path.

2. The reverse osmosis filtration system without pressure tanks according to claim 1, characterized in that: the secondary filter element and the tertiary filter element are both reverse osmosis filter elements.

3. The reverse osmosis filtration system without pressure tanks according to claim 2, characterized in that: the pure water obtained by filtering the wastewater effluent of the secondary filter element through the tertiary filter element, together with the pure water of the secondary filter element, is discharged from the pure water outlet of the reverse osmosis filtration system without pressure tanks.

4. The reverse osmosis filtration system without pressure tanks according to claim 3, characterized in that: a post carbon filter is connected to the connecting body of the filter element connecting member for a sealed fluidic connection with the internal water path; and, the pure water obtained by filtering the wastewater effluent of the secondary filter element through the tertiary filter element and the pure water of the secondary filter element are filtered through the post carbon filter followed by being discharged from the pure water outlet of the reverse osmosis filtration system without pressure tanks.

5. The reverse osmosis filtration system without pressure tanks according to claim 4, characterized in that: in the filter element connecting member,
on the filter element installing side,
the primary filter element coupling base is provided with a primary filter inlet and a primary filter pure water outlet, the secondary filter element coupling base is provided with a secondary filter inlet, a secondary filter pure water outlet and a secondary filter wastewater outlet, and the tertiary filter element coupling base is provided with a tertiary filter inlet, a tertiary filter pure water outlet and a tertiary filter wastewater outlet;
on the internal water path side,
the internal water path is divided into a primary filter inlet zone, a primary filter pure water outlet zone, a secondary filter pure water outlet zone, a secondary filter wastewater outlet zone, a tertiary filter wastewater outlet zone, a post carbon filter inlet zone and a post carbon filter pure water outlet zone; wherein
the raw water inlet of the reverse osmosis filtration system without pressure tanks has a fluidic connection with the primary filter inlet through the primary filter inlet zone, the primary filter pure water outlet has a fluidic connection with the secondary filter inlet through the primary filter pure water outlet zone;
the secondary filter pure water outlet has a fluidic connection with the tertiary filter pure water outlet through the secondary filter pure water outlet zone; the secondary filter pure water outlet zone has a fluidic connection with the post carbon filter inlet zone through a first external pipeline; the post carbon filter inlet zone has a sealed fluidic connection with the post carbon filter through a second external pipeline so as to fluidly connect to the post carbon filter pure water outlet zone through a third external pipeline; the post carbon filter pure water outlet zone has a fluidic connection with the pure water outlet of the reverse osmosis filtration system without pressure tanks; and
the secondary filter wastewater outlet has a fluidic connection with the tertiary filter inlet through the secondary filter wastewater outlet zone; the tertiary filter wastewater outlet has a fluidic connection with the wastewater outlet of the reverse osmosis filtration system without pressure tanks through the tertiary filter wastewater outlet zone.

6. The reverse osmosis filtration system without pressure tanks according to claim 5, characterized in that: the internal water path is formed on the internal water path side by hot-plate welding.

7. The reverse osmosis filtration system without pressure tanks according to claim 5, characterized in that: a flowmeter is positioned on the first external pipeline.

8. The reverse osmosis filtration system without pressure tanks according to claim 5, characterized in that: a primary filter element coupling block, a secondary filter element coupling block and a tertiary filter element coupling block are separately disposed on the primary filter element coupling base, the secondary filter element coupling base and the tertiary filter element coupling base to fluidly connect the primary filter element, the secondary filter element, the tertiary filter element with the corresponding grade of the filter element coupling bases respectively; wherein
the primary filter element coupling block contains a first mid-block and a first cap;
the first mid-block is provided with a primary filter element inlet end matching the primary filter inlet of the primary filter element coupling base, and a primary filter element outlet end matching the primary filter pure water outlet of the primary filter element coupling base;
a first arc groove and a first circular groove corresponding to the primary filter element outlet end are formed on the first cap, through which the primary filter element inlet end and the primary filter element outlet end pass, so that the first mid-block slides along the first arc groove;
the secondary filter element coupling block contains a second mid-block and a second cap;
the second mid-block is provided with a secondary filter element inlet end matching the secondary filter inlet of the secondary filter element coupling base, a secondary filter element outlet end matching the secondary filter pure water outlet of the secondary filter element coupling base, and a secondary filter element wastewater outlet end matching the secondary filter wastewater outlet of the secondary filter element coupling base;
a second arc groove and a second circular groove corresponding to the secondary filter element outlet end and the secondary filter element wastewater outlet end are formed on the second cap, through which the secondary filter element inlet end, the secondary filter element outlet end and the secondary filter element wastewater outlet end pass, so that the second mid-block slides along the second arc groove;
the tertiary filter element coupling block contains a third mid-block and a third cap;
the third mid-block is provided with a tertiary filter element inlet end matching the tertiary filter inlet of the tertiary filter element coupling base, a tertiary filter element outlet end matching the tertiary filter pure water outlet of the tertiary filter element coupling base, and a tertiary filter element wastewater outlet end matching the tertiary filter wastewater outlet of the tertiary filter element coupling base;
a third arc groove and a third circular groove corresponding to the tertiary filter element outlet end and the tertiary filter element wastewater outlet end are formed on the third cap, through which the tertiary filter element inlet end, the tertiary filter element outlet end and the tertiary filter element wastewater outlet end pass, so that the third mid-block slides along the third arc groove.

9. The reverse osmosis filtration system without pressure tanks according to any one of claim 1, characterized in that: the filter element connecting member further contains a housing for receiving the connecting body, and a base to which the housing is connected and mounted.

10. The reverse osmosis filtration system without pressure tanks according to any one of claim 1, characterized in that: the pure water outlet of the reverse osmosis filtration system without pressure tanks is connected to a dual switch non-pressure tap.
